(19) United States
(12) Patent Application Publication
(10) Pub. No.: US 2026/0332312 A1
(43) Pub. Date: Oct. 22, 2026

(54) Configured Grant Timer Logic for Extended Reality Applications

(71) Applicant: Apple Inc., Cupertino, CA (US)

(72) Inventors: Ping-Heng KUO, London (GB); Fangli XU, Beijing (CN); Haijing HU, Los Gatos, CA (US); Ralf ROSSBACH, Munich (DE)

(21) Appl. No.: 19/116,666

(22) PCT Filed: Sep. 29, 2022
(86) PCT No.: PCT/CN2022/122760

§ 371 Date: Mar. 28, 2025

(51) Int. Cl. H04L 1/1822; H04W 72/12; H04W 76/28

(52) U.S. Cl. CPC H04L 1/1822; H04W 72/12; H04W 76/28

(57) ABSTRACT

A user equipment (VE) is configured to operate the UE in a discontinuous reception (DRX) mode comprising a DRX OnDuration where the UR monitors a Physical Downlink Control Channel (PDCCH) and a DRX OffDuration where the UE does not monitor the PDCCH, transmit, during the DRX OnDuration, first data to a network or a device using a first grant, identify a first hybrid automatic repeat request (HARQ) process associated with the first grant, start a first timer associated with the first HARQ process upon transmitting the first data using the grant, wherein the UE is prevented from transmitting data using any configured grant (CG) associated with the first HARQ process while the timer is running and stop the first timer when the UE transitions from the DRX OnDuration to the DRX OffDuration.

### BACKGROUND

Extended reality (XR) devices and services will increase in availability, capability, and market penetration in coming years. It is desirable to implement power savings for demanding XR services. An XR user equipment (XR UE, henceforth “UE”) may achieve power savings by staying in a discontinuous reception (DRX)-off mode when the UE does not expect to receive dynamic downlink (DL) assignments for DL XR traffics.

This power saving scheme is often thwarted by the coexistence of uplink (UL) traffic (e.g., a pose update of a user). XR applications require highly accurate and low latency tracking of the UE. These UL traffics are typically transmitted via configured grants (CGs), which may cause the UE to frequently wake to receive potential UL retransmission grants after each CG physical uplink shared channel (PUSCH) is performed. Consequently, UEs spend much of their time in the DRX-on mode, thereby limiting the benefits of the aforementioned power saving scheme.

According to new radio (NR) specifications, each CG PUSCH is associated with a hybrid automatic repeat request (HARQ) process ID, which may be derived from a specified formula. A CG configuration may comprise multiple CG PUSCHs with the same HARQ process ID. A configured grant (CG) timer typically starts when a PUSCH is transmitted (on the first orthogonal frequency division multiplexing (OFDM) symbol of the PUSCH). The CG timer is associated with the HARQ process of the PUSCH. The PUSCH may be a configured grant or a dynamic grant (DG). While the CG timer associated with the HARQ process is running, the UE does not use CG resources with the same HARQ process. This avoids the medium access control (MAC) protocol data unit (PDU) stored in the HARQ buffer from being overwritten by a new transmission while the stored MAC PDU is still needed for HARQ retransmission.

### SUMMARY

Some exemplary embodiments are related to a method performed by a user equipment (UE), The method includes operating the UE in a discontinuous reception (DRX) mode comprising a DRX OnDuration where the UR monitors a Physical Downlink Control Channel (PDCCH) and a DRX OffDuration where the UE does not monitor the PDCCH, transmitting, during the DRX OnDuration, first data to a network or a device using a first grant, identifying a first hybrid automatic repeat request (HARQ) process associated with the first grant, starting a first timer associated with the first HARQ process upon transmitting the first data using the grant, wherein the UE is prevented from transmitting data using any configured grant (CG) associated with the first HARQ process while the timer is running and stopping the first timer when the UE transitions from the DRX OnDuration to the DRX OffDuration.

Other exemplary embodiments are related to a method performed by a user equipment (UE). The method includes operating the UE in a discontinuous reception (DRX) mode comprising a DRX OnDuration and a DRX OffDuration, transmitting data to a network or a device using a grant, determining whether the grant occurs during the DRX OnDuration or the DRX OffDuration, when the grant occurs during the DRX OnDuration, starting a timer associated with a hybrid automatic repeat request (HARQ) process associated with the grant upon transmitting the data using the grant, wherein the UE is prevented from transmitting data using any configured grant (CG) associated with the HARQ process while the timer is running and when the grant occurs during the DRX OffDuration, determining whether to start the timer.

Still further exemplary embodiments are related to a method performed by a user equipment (UE). The method includes operating the UE in a discontinuous reception (DRX) mode comprising a DRX OnDuration and a DRX OffDuration, transmitting, during the DRX OnDuration, first data to a network or a device using a grant, identifying a hybrid automatic repeat request (HARQ) process associated with the grant and starting a timer associated with the first HARQ process upon transmitting the first data using the grant, wherein the VE is prevented from transmitting data using any configured grant associated with the first HARQ process while the timer is running during the DRX OnDuration and, wherein the UE is allowed to transmit data using any configured grant associated with the first HARQ process while the timer is running during the DRX OffDuration.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows a diagram for stopping CG timers upon entering a DRX-off state according to various exemplary embodiments.

FIG. 5 shows a flow diagram for stopping CG timers upon entering a DRX-off state according to various exemplary embodiments.

FIG. 6 shows a diagram for refraining from starting CG timers in a DRX OffDuration according to various exemplary embodiments.

FIG. 7 shows a flow diagram for refraining from starting CG timers in a DRX OffDuration according to various exemplary embodiments.

FIG. 8 shows a diagram for allowing HARQ process overwriting during a DRX OffDuration according to various exemplary embodiments.

FIG. 9 shows a flow diagram for allowing HARQ process overwriting during a DRX OffDuration according to various exemplary embodiments.

### DETAILED DESCRIPTION

The exemplary embodiments may be further understood with reference to the following description and the related appended drawings, wherein like elements are provided with the same reference numerals. The exemplary embodiments relate to improved configured grant (CG) timer logic.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network.

The exemplary embodiments are also described with reference to a discontinuous reception (DRX) cycle. The DRX cycle has an OnDuration and an OffDuration. Those skilled in the art will understand the operations that are performed by a UE when in the DRX OnDuration and DRX OffDuration. One general example of operations is that during the DRX OnDuration, the UE will monitor the Physical Downlink Control Channel (PDCCH) and in the DRX OffDuration, the UE will not monitor the PDCCH. It should be understood that other operations may also occur during the DRX cycle.

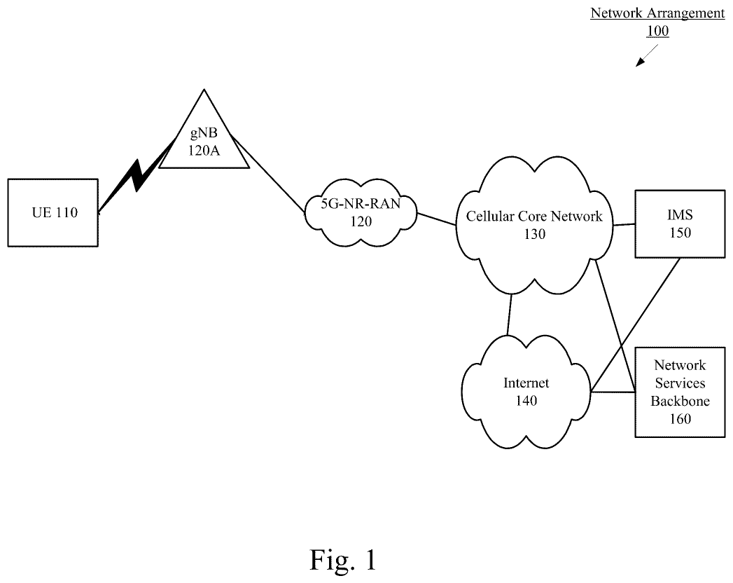

FIG. 1 shows an exemplary network arrangement 100 according to various exemplary embodiments. The exemplary network arrangement 100 includes a UE 110, Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc. ) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

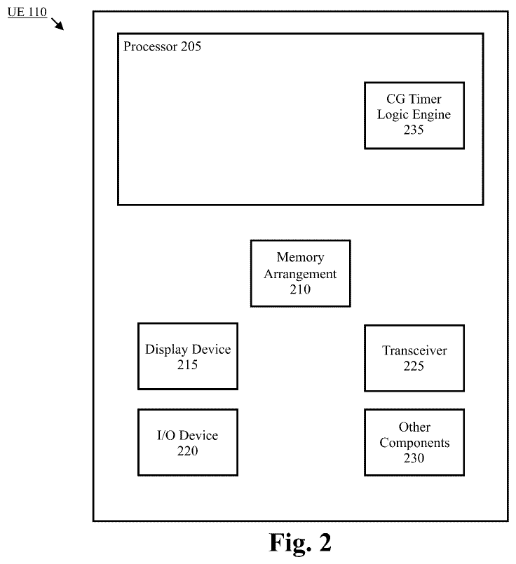

FIG. 2 shows an exemplary VE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230.

The other components 230 may include, for example, an audio input device, an audio output device, a battery that provides a limited power supply, a data acquisition device, ports to electrically connect the VE 110 to other electronic devices, sensors to detect conditions of the UE 110, etc.

The processor 205 may be configured to execute a plurality of engines for the UE 110. For example, the engines may include a CG timer logic engine 235 for performing operations related to the CG timer logic based on a DRX state. Examples of the operations will be described in greater detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies). For example, the transceiver 225 may operate on the unlicensed spectrum when e.g., NR-U is configured.

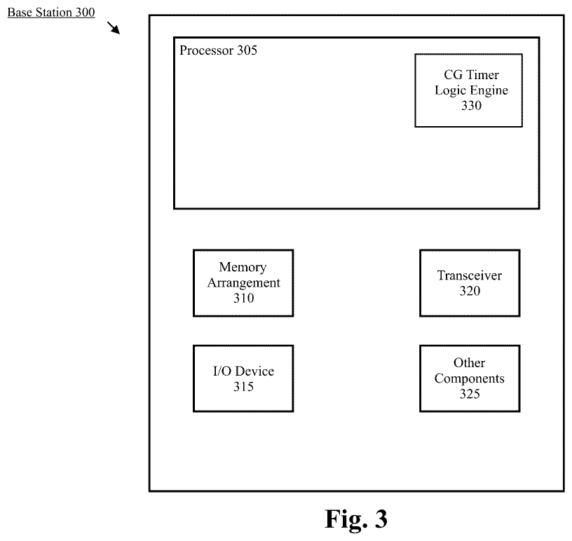

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a CG timer logic engine 330 for performing operations such related to the CG timer logic based on a DRX state. Examples of the operations will be described in greater detail below.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

In a first aspect of the exemplary embodiments, a logic of stopping a CG timer upon entering a DRX OffDuration is proposed. In the first aspect, it is proposed that a running CG timer (e.g., the CG timer started by a Dynamic Grant (DG) PUSCH and/or CG PUSCH when the UE was in a DRX OnDuration) is stopped when the UE enters a DRX OffDuration.

In a first option of the first aspect, the aforementioned stopping of a running CG timer is applied to all CG timers associated with all HARQ processes. Thus, any CG timers started before the UE enters a DRX OffDuration should be stopped.

In a second option of the first aspect, only CG timers associated with a subset of HARQ processes or a subset of CG configurations (e.g., Type-1 CG or Type-2 CG) are stopped upon the UE entering a DRX-off state. Thus, only the CG timers associated with specific HARQ processes started before the entry to DRX OffDuration should be stopped. For example, the HARQ processes configured for a specific CG configuration may be stopped.

It should be understood that whether the UE stops the CG timer upon entering the DRX-off interval may also depend on the contents of the MAC PDU stored in the corresponding HARQ process. For example, the UE may not stop the CG timer if certain logical channels (LCHs)/data radio bearers (DRBs)/quality of service (QoS) flows and/or MAC CEs are included in the MAC PDU. The UE may also determine if the CG timer should be stopped upon entering the DRX-off interval based on if user data is absent or if any user data is present in the MAC PDU stored in the corresponding HARQ process.

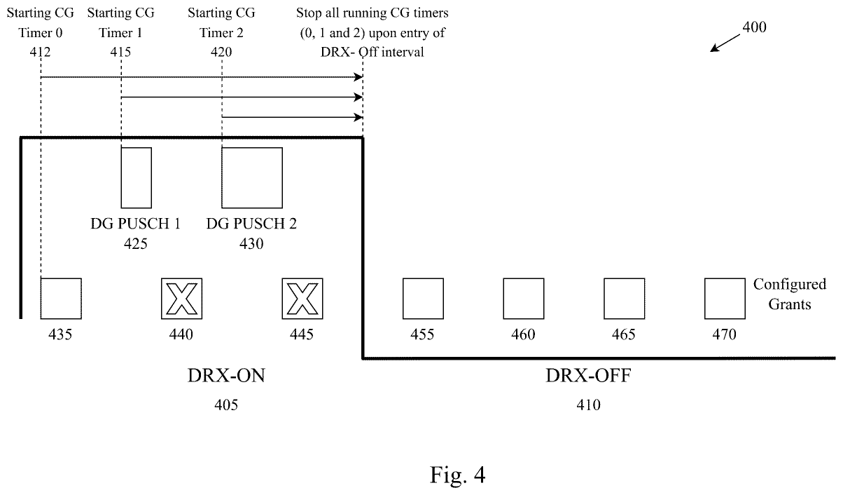

FIG. 4 shows a diagram for stopping CG timers upon entering a DRX-off state according to various exemplary embodiments. FIG. 4 shows that the UE is operating in the DRX state including an OnDuration 405 and an OffDuration 410. FIG. 4 also shows that the UE includes a series of configured grants (CGs) 435-470, a dynamic grant (DG) 425 and a DG 430. In this example, it may be considered that the CGs 435-470 are associated with a first HARQ process, the DG 425 is associated with a second HARQ process and the DG 430 is associated with a third HARQ process.

It may be considered that the UE transmits data to the network using the CG 435. This starts a CG timer 412 associated with the first HARQ process. As shown in FIG. 4, as long as the CG timer 412 is running, the UE is not allowed to transmit on a CG having the same HARQ process as the CG 435, e.g., CGs 440, 445.

Similarly, the VE may transmit data using the DG 425. This starts a CG timer 415 associated with the second HARQ process. The UE may also transmit data using the DG 430. This starts a CG timer 420 associated with the third HARQ process. Thus, similar to the description above, the UE is not allowed to transmit on any grants having the same HARQ process as the DG 425 and DG 430 as long as the respective timers are running.

The UE may then switch from the OnDuration 405 to the OffDuration 410. As described above, the first aspect of the exemplary embodiments include stopping CG timer(s) upon entering a DRX OffDuration. In this example, it is shown that each of the CG timers 412, 415, and 420 are stopped when the UE enters the DRX OffDuration. Thus, when the UE is in the DRX OffDuration, the UE will not be prevented from transmitting on any grants that are associated with the respective HARQ process, e.g., in this example, the first through third HARQ processes. This is depicted in FIG. 4 for the first HARQ process because the UE is allowed to transmit using the CGs 455, 460, 465, and 470 that occur during the DRX OffDuration, e.g., these CGs 455-470 are not blocked by the running CG timer 412.

In this example, it was considered that the first option was used because all the CG timers were stopped 412, 415, and 420. However, as also described above, a second option may be implemented where only a portion of the CG timers are stopped. For example, it may be configured that the CG timers 412 and 420 are stopped but the CG timer 415 continues to run. As described above, this configuration may be based on a subset of CG configurations (e.g., Type-1 CG or Type-2 CG) or any other factor.

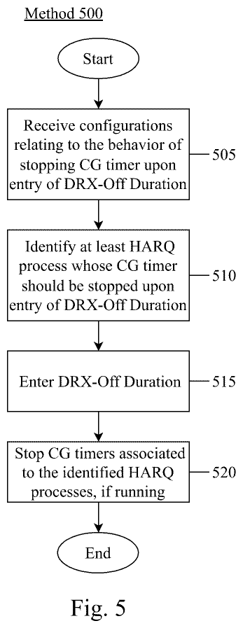

FIG. 5 shows a flow diagram for stopping CG timers upon entering a DRX-off state according to various exemplary embodiments. In 505, the UE 110 receives configurations relating to the behavior of stopping CG timer(s) upon entering a DRX OffDuration. These configurations may include the behaviors described with respect to the first and second options of the first aspect above.

In 510, the UE 110 identifies all HARQ process with a CG timer that should be stopped upon the UE 110 entering a DRX OffDuration. In 515, the UE 110 enters the DRX OffDuration. In 520, the UE 110 stops any running CG timers associated with the identified HARQ processes.

In a second aspect of the exemplary embodiments, a logic of refraining from starting CG timers in a DRX OffDuration is proposed. In the second aspect, CG transmissions that are performed during a DRX OffDuration may not automatically start a CG timer. Instead, a UE may determine whether a CG timer should be started with a CG PUSCH based on whether the CG PUSCH occurs in a DRX OnDuration or a DRX OffDuration. It should be understood that the logic of the first and second aspects may be implemented separately without the other aspect or used jointly where both the first and second aspects are implemented.

In some exemplary embodiments, this logic may be configured on a per CG configuration basis. That is, all CG occasions in a specific CG configuration may not start a CG timer when the UE is in a DRX OffDuration. In other exemplary embodiments, this logic may be configured on a per HARQ process basis. In this case, only the CG occasions with specific HARQ processes do not start the CG timer when the UE is in a DRX OffDuration. In further exemplary embodiments, this logic may be configured on a per MAC entity basis. In this case, all CG occasions associated with the identified MAC entity do not start a CG timer when the UE is in a DRX OffDuration.

Whether the UE starts a CG timer for CG PUSCH in a DRX OffDuration may also depend on the contents of the MAC PDUs to be transmitted. For example, the UE may still start a CG timer if certain LCHs/DRBs/QoS flows and/or MAC CEs are included in the MAC PDU. The UE may also determine whether a CG timer should be started based on if user data is absent or if any user data is present in the MAC PDU to be transmitted.

In some exemplary embodiments, the UE may also determine if a CG timer should be started with a CG PUSCH based on the time interval between the CG PUSCH and the entry to the next DRX OnDuration. For example, if the CG PUSCH is close to a point in time where the next DRX OnDuration is going to start, the UE may start the CG timer. Whereas, if the CG PUSCH is not close to a point in time where the next DRX OnDuration is going to start, the UE may not start the CG timer. The determination of close or not close may be based on any number of factors, e.g., a time duration until the next DRX OnDuration starts, a number of CGs between the current CG and the next DRX OnDuration, etc.

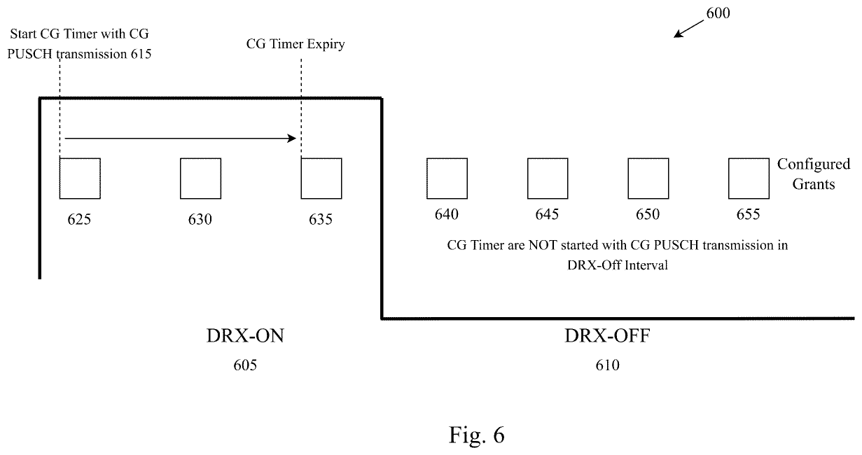

FIG. 6 shows a diagram for refraining from starting CG timers in a DRX OffDuration according to various exemplary embodiments. Similar to FIG. 4, FIG. 6 shows that the VE is operating in the DRX state including an OnDuration 605 and an OffDuration 610. In this example, it may be considered that all the CGs 625-655 are associated with the same HARQ process.

While in the OnDuration 605, it may be considered that the UE transmitted data using the CG 625. This started the CG timer 615, thereby preventing the UE from transmitting using the CG 630 because the CG timer 615 is still running. In this example, the CG timer 615 expires prior to the CG 635. Thus, the UE may transmit using the CG 635, but does not in this example. In addition, as described above, if the UE transmitted using the CG 635 and the CG timer 615 was started again and the first aspect was implemented, the CG timer 615 would be stopped when the UE transitioned to the DRX OffDuration 610.

As shown in FIG. 6, in this example, the CGs 640-655 are configured during the DRX OffDuration 610. As described above, in these exemplary embodiments, the CG timer(s) will not be started during the DRX OffDuration 610. Thus, the UE may transmit using one or more of the CGs 640-655 and the corresponding CG timer will not start during the DRX OffDuration 610.

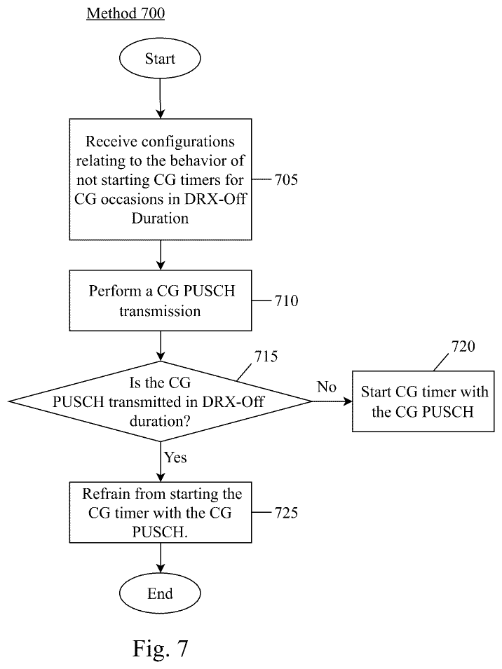

FIG. 7 shows a flow diagram for refraining from starting CG timers in a DRX OffDuration according to various exemplary embodiments. In 705, the UE 110 receives configurations related to the logic of not starting CG timers for CG occasions during DRX OffDurations. In 710, the UE 110 performs a CG PUSCH transmission.

In 715, the UE 110 determines if the CG PUSCH transmission 710 was transmitted during a DRX OffDuration. If the UE determines the CG PUSCH was transmitted during a DRX OffDuration, the UE 110 proceeds to 725 where the UE 110 refrains from starting a CG timer associated with the CG PUSCH. If the UE determines the CG PUSCH was transmitted during a DRX OnDuration, e.g., not during a DRX OffDuration, the UE 110 starts a CG timer associated with the CG PUSCH.

In a third aspect of the exemplary embodiments, a logic for allowing HARQ process overwriting during a DRX OffDuration is proposed. In the third aspect, the UE may use CG resources for new transmissions even if the CG timer associated with the corresponding HARQ processes are still running during a DRX OffDuration. This behavior may be configured by a gNB.

Typically, retransmission is not expected during DRX OffDurations. Thus, blocking CG resources during the DRX OffDurations may not be necessary. Thus, in this third aspect, allowing the UE to use CG resources with CG timers that are still running during a DRX OffDuration may facilitate faster uplink transmissions and improve latency.

In some exemplary embodiments, the UE may be configured to enable this logic only if the UE intends to transmit data from certain LCHs, radio bearers or QoS flows on the CG resources (e.g., LCHs with priority higher than a specified threshold, LCHs with higher priority than the LCHs included in the MAC PDU that is already stored in the HARQ process, etc.). If the gNB pre-configures the UE to use this logic, the gNB should not expect HARQ retransmission to be performed within the DRX OffDuration. In other words, such configuration logic may implicitly indicate that HARQ retransmission is not enabled during a DRX OffDuration.

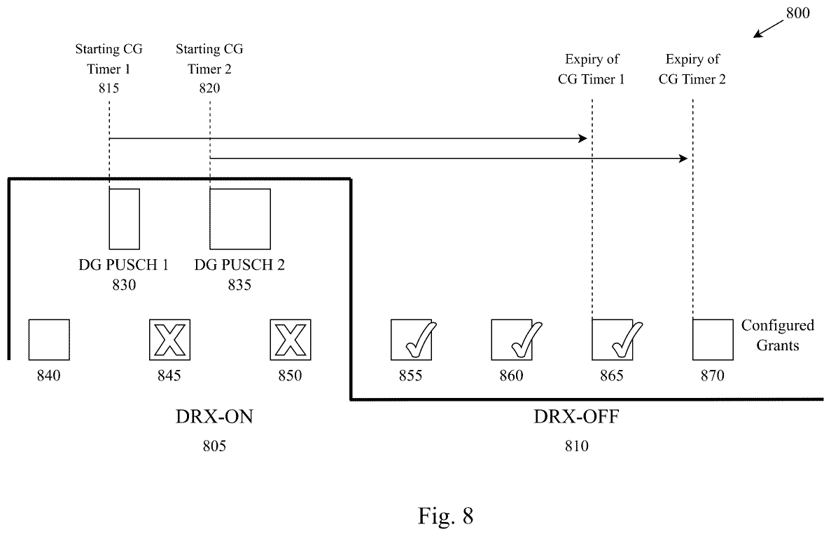

FIG. 8 shows a diagram for allowing HARQ process overwriting during a DRX OffDuration according to various exemplary embodiments. Similar to FIG. 4, FIG. 8 shows that the UE is operating in the DRX state including an OnDuration 805 and an OffDuration 810. FIG. 8 also shows that the UE includes a series of configured grants (CGs) 840-870, a dynamic grant (DG) 830 and a DG 835. In this example, it may be considered that the DG 830 is associated with a first HARQ process and the DG 835 is associated with a second HARQ process. Some of the CGs 840-870 may be associated with the first HARQ process and other ones of the CGs 840-870 may be associated with the second HARQ process, For the purposes of this example, it is not necessary to specify with which HARQ process a specific CG is associated.

Initially, it may be considered that there is no transmission related to CG 840. In this example, it may be considered that the UE may transmit data using the DG 830. This starts a CG timer 815 associated with the first HARQ process. The UE may also transmit data using the DG 835. This starts a CG timer 420 associated with the second HARQ process. Thus, based on the running CG timers 815 and 820, the UE is not allowed to transmit on the CGs 845 and 850 that occur during the OnDuration 805.

The UE then transitions to the OffDuration 810. In this exemplary embodiment, the CG timers 815 and 820 continue to run. Under conventional logic, the UE should not be able to transmit on any grants having the same HARQ processes as the DG 425 and DG 430 as long as the respective timers are running. However, as described above, in the third aspect of the exemplary embodiments, the UE may be configured to transmit new transmissions during the OffDuration 810 using CG resources even if the corresponding CG timer is running. As described above, this is because it is not expected that any retransmissions will occur during the OffDuration 810.

Thus, even though the CG timer 815 is running during CGs 855 and 860 and CG timer 820 is running during CGs 855-865, the VE may use these CGs that occur during the OffDuration 810 for new transmissions.

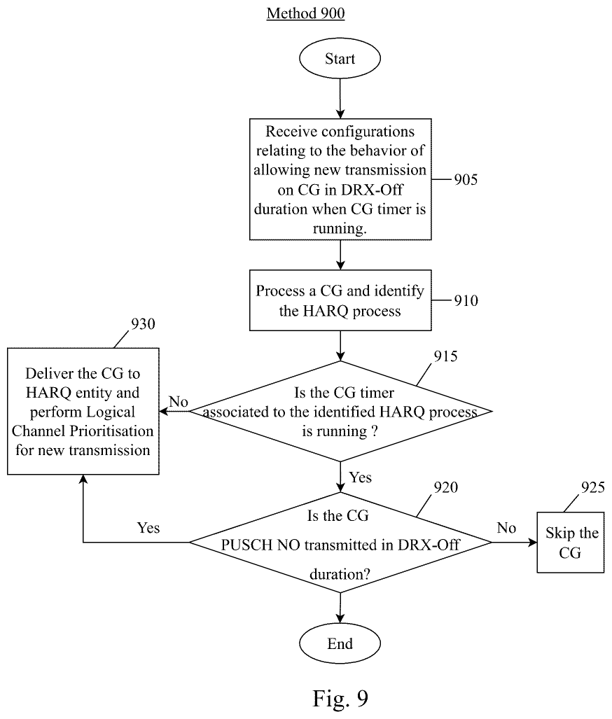

FIG. 9 shows a flow diagram for allowing HARQ process overwriting during a DRX OffDuration according to various exemplary embodiments. In 905, the UE 110 receives configurations related to the logic of allowing new transmissions using CG during a DRX OffDuration while a corresponding CG timer is running. In 910, the UE 110 processes a CG and identifies the HARQ process. In 915, the UE 110 decides if the CG timer associated with the identified HARQ process is running.

If the CG timer associated with the identified HARQ process is not running in 915, the UE 110 proceeds to 930 where the UE 110 delivers the CG to the HARQ entity and performs LCH prioritization to construct a MAC PDU for a new transmission. If the CG timer associated with the identified HARQ process is running in 915, the UE 110 proceeds to 920, where the UE 110 decides if the CG PUSCH is being transmitted during a DRX OffDuration.

If the CG PUSCH is being transmitted during a DRX OffDuration in 920, the VE 110 proceeds to 930 as described above. If the CG PUSCH is not being transmitted during a DRX OffDuration in 920, the UE 110 proceeds to 925 and skips the CG.

It should be understood that while the exemplary embodiments are described with respect to a CG timer, it is possible to apply the same embodiments to CG retransmission timers (CGRTs) as well. CGRTs typically begin with CG PUSCH, similar to CG timers. CGRTs are typically configured in unlicensed band operations. When a CGRT expires, if the UE did not receive downlink feedback information (DFI) regarding the status of the corresponding HARQ process, the UE may perform autonomous retransmission using the subsequent CG resource.

In a modification to the first aspect, the UE may stop both the CG timer and CGRT when entering a DRX-Off state. Alternatively, the UE may only stop the CG timer, but the CGRT may continue to run when entering DRX-Off state, which allows for autonomous retransmission during a DRX-off state.

In a modification to the second aspect, the UE may not start both the CG timer and the CGRT when the UE is in a DRX-Off state. Alternatively, the VE may not start the CG timer, but it may start a CGRT with a CG PUSCH transmission when the UE is in a DRX-off state.

In a modification to the third aspect, the VE may perform autonomous retransmission for a HARQ process on any suitable CG resource, even if the corresponding CGRT is still running, while the UE is in DRX-Off state.

### EXAMPLES

In a first example, a processor of a user equipment (UE) is configured to perform operations comprising operating the UE in a discontinuous reception (DRX) mode comprising a DRX OnDuration where the UR monitors a Physical Downlink Control Channel (PDCCH) and a DRX OffDuration where the UE does not monitor the PDCCH, transmitting, during the DRX OnDuration, first data to a network or a device using a first grant, identifying a first hybrid automatic repeat request (HARQ) process associated with the first grant, starting a first timer associated with the first HARQ process upon transmitting the first data using the grant, wherein the UE is prevented from transmitting data using any configured grant (CG) associated with the first HARQ process while the timer is running and stopping the first timer when the UE transitions from the DRX OnDuration to the DRX OffDuration.

In a second example, the processor of the first example, wherein the operations further comprise transmitting, during the DRX OnDuration, second data to the network using a second grant configured by the network, identifying a second HARQ process associated with the grant, starting a second timer associated with the second HARQ process upon transmitting the data using the second grant, wherein the UE is prevented from transmitting data using any configured grant (CG) associated with the second HARQ process while the timer is running, wherein the stopping the timer comprises stopping the first timer and the second timer.

In a third example, the processor of the first example, wherein the operations further comprise transmitting, during the DRX OnDuration, second data to the network using a second grant configured by the network, identifying a second HARQ process associated with the grant, starting a second timer associated with the second HARQ process upon transmitting the data using the second grant, wherein the UE is prevented from transmitting data using any configured grant (CG) associated with the second HARQ process while the timer is running, wherein the stopping the timer comprises stopping one of the first timer or the second timer.

In a fourth example, the processor of the third example, wherein the one of the first timer or the second timer is based on a configuration received from the network.

In a fifth example, the processor of the fourth example, wherein the configuration comprises an identification of the corresponding HARQ process or a configured grant (CG) configuration.

In a sixth example, the processor of the first example, wherein the timer is a configured grant (CG) timer or a CG retransmission timer (CGRT).

In a seventh example, the processor of the first example, wherein the grant is a configured grant or a dynamic grant.

In an eighth example, a user equipment comprising a transceiver configured to communicate with a network or device and a processor of any of the first to seventh examples communicatively coupled to the transceiver.

In a ninth example, a non-transitory computer readable storage medium comprising a set of instructions that are executable to perform any of the operations of the first to seventh examples.

In a tenth example, a processor of a user equipment (UE) is configured to perform operations comprising operating the UE in a discontinuous reception (DRX) mode comprising a DRX OnDuration and a DRX OffDuration, transmitting data to a network or a device using a grant, determining whether the grant occurs during the DRX OnDuration or the DRX OffDuration, when the grant occurs during the DRX OnDuration, starting a timer associated with a hybrid automatic repeat request (HARQ) process associated with the grant upon transmitting the data using the grant, wherein the UE is prevented from transmitting data using any configured grant (CG) associated with the HARQ process while the timer is running and when the grant occurs during the DRX OffDuration, determining whether to start the timer.

In an eleventh example, the processor of the tenth example, wherein determining whether to start the timer is based on a configuration of the grant.

In a twelfth example, the processor of the tenth example, wherein determining whether to start the timer is based on an identification of the HARQ process.

In a thirteenth example, the processor of the tenth example, wherein determining whether to start the timer is based on an identification of a medium access control (MAC) entity performing the transmitting.

In a fourteenth example, the processor of the tenth example, wherein determining whether to start the timer is based on a time until a next DRX OnDuration occurs.

In a fifteenth example, the processor of the tenth example, wherein the timer is a configured grant (CG) timer or a CG retransmission timer (CGRT).

In a sixteenth example, the processor of the tenth example, wherein the grant is a configured grant or a dynamic grant.

In a seventeenth example, a user equipment comprising a transceiver configured to communicate with a network or device and a processor of any of the tenth to sixteenth examples communicatively coupled to the transceiver.

In an eighteenth example, a non-transitory computer readable storage medium comprising a set of instructions that are executable to perform any of the operations of the tenth to sixteenth examples.

In a nineteenth example, a processor of a user equipment (UE) is configured to perform operations comprising operating the UE in a discontinuous reception (DRX) mode comprising a DRX OnDuration and a DRX OffDuration, transmitting, during the DRX OnDuration, first data to a network or a device using a grant, identifying a hybrid automatic repeat request (HARQ) process associated with the grant and starting a timer associated with the first HARQ process upon transmitting the first data using the grant, wherein the UE is prevented from transmitting data using any configured grant associated with the first HARQ process while the timer is running during the DRX OnDuration and, wherein the UE is allowed to transmit data using any configured grant associated with the first HARQ process while the timer is running during the DRX OffDuration.

In a twentieth example, the processor of the nineteenth example, wherein the transmitting data using any configured grant associated with the first HARQ process while the timer is running during the DRX OffDuration does not apply to retransmissions.

In a twenty first example, the processor of the twentieth example, wherein retransmissions associated with the first HARQ process are allowed during the DRX OffDuration when the timer expires.

In a twenty second example, the processor of the nineteenth example, wherein the operations further comprise receiving, from the network, a configuration related to the transmission of data during the DRX OffDuration, wherein the configuration comprises an indication of a logical channel (LCH), a radio bearer or a quality of service (QoS) flow for which transmitting data using any grant associated with the first HARQ process while the timer is running during the DRX OffDuration is allowed.

In a twenty third example, the processor of the twenty second example, wherein the indication of the LCH comprises an indication of a priority of the LCH.

In a twenty fourth example, the processor of the nineteenth example, wherein the operations further comprise determining, whether a transmission of second data using any configured grant associated with the first HARQ process while the timer is running during the DRX OffDuration is allowed based on a logical channel (LCH), a radio bearer or a quality of service (QoS) flow relating to at least one of the first data and the second data.

In a twenty fifth example, the processor of the nineteenth example, wherein the timer is a configured grant (CG) timer or a CG retransmission timer (CGRT).

In a twenty sixth example, the processor of the nineteenth example, wherein the grant is a configured grant or a dynamic grant.

In a twenty seventh example, a user equipment comprising a transceiver configured to communicate with a network or device and a processor of any of the nineteenth to twenty sixth examples communicatively coupled to the transceiver.

In an twenty eighth example, a non-transitory computer readable storage medium comprising a set of instructions that are executable to perform any of the operations of the nineteenth to twenty sixth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
operating the UE in a discontinuous reception (DRX) mode comprising a DRX OnDuration where the UE monitors a Physical Downlink Control Channel (PDCCH) and a DRX OffDuration where the UE does not monitor the PDCCH;
transmitting, during the DRX OnDuration, first data to a network or a device using a first grant;
identifying a first hybrid automatic repeat request (HARQ) process associated with the first grant;
starting a first timer associated with the first HARQ process upon transmitting the first data using the first grant, wherein the UE is prevented from transmitting data using any configured grant (CG) associated with the first HARQ process while the first timer is running; and
stopping the first timer when the UE transitions from the DRX OnDuration to the DRX OffDuration.

2. The method of claim 1, further comprising:
transmitting, during the DRX OnDuration, second data to the network using a second grant configured by the network;
identifying a second HARQ process associated with the second grant; and
starting a second timer associated with the second HARQ process upon transmitting the second data using the second grant, wherein the UE is prevented from transmitting data using any configured grant (CG) associated with the second HARQ process while the second timer is running,
wherein the stopping the timer comprises stopping the first timer and the second timer are stopped.

3. The method of claim 1, further comprising:
transmitting, during the DRX OnDuration, second data to the network using a second grant configured by the network;
identifying a second HARQ process associated with the second grant; and
starting a second timer associated with the second HARQ process upon transmitting the second data using the second grant, wherein the UE is prevented from transmitting data using any configured grant (CG) associated with the second HARQ process while the second timer is running,
wherein the stopping the timer comprises stopping one of the first timer or the second timer are stopped.

4. The method of claim 3, wherein the one of the first timer or the second timer is based on a configuration received from the network.

5. The method of claim 4, wherein the configuration comprises an identification of the corresponding HARQ process or a configured grant (CG) configuration.

6. The method of claim 1, wherein the first timer is a configured grant (CG) timer or a CG retransmission timer (CGRT).

7. The method of claim 1, wherein the first grant is a configured grant or a dynamic grant.

8. A method performed by a user equipment (UE), comprising:
operating the UE in a discontinuous reception (DRX) mode comprising a DRX OnDuration and a DRX OffDuration;
transmitting data to a network or a device using a grant;
determining whether the grant occurs during the DRX OnDuration or the DRX OffDuration;
when the grant occurs during the DRX OnDuration, starting a timer associated with a hybrid automatic repeat request (HARQ) process associated with the grant upon transmitting the data using the grant, wherein the UE is prevented from transmitting data using any configured grant (CG) associated with the HARQ process while the timer is running; and
when the grant occurs during the DRX OffDuration, determining whether to start the timer.

9. The method of claim 8, wherein determining whether to start the timer is based on a configuration of the grant.

10. The method of claim 8, wherein determining whether to start the timer is based on an identification of the HARQ process.

11. The method of claim 8, wherein determining whether to start the timer is based on an identification of a medium access control (MAC) entity performing the transmitting.

12. The method of claim 8, wherein determining whether to start the timer is based on a time until a next DRX OnDuration occurs.

13. The method of claim 8, wherein the timer is a configured grant (CG) timer or a CG retransmission timer (CGRT).

14. The method of claim 8, wherein the grant is a configured grant or a dynamic grant.

15. A method performed by a user equipment (UE), comprising:
operating the UE in a discontinuous reception (DRX) mode comprising a DRX OnDuration and a DRX OffDuration;
transmitting, during the DRX OnDuration, first data to a network or a device using a grant;
identifying a hybrid automatic repeat request (HARQ) process associated with the grant; and
starting a timer associated with the first HARQ process upon transmitting the first data using the grant,
wherein the UE is prevented from transmitting data using any configured grant associated with the first HARQ process while the timer is running during the DRX OnDuration and,
wherein the UE is allowed to transmit data using any configured grant associated with the first HARQ process while the timer is running during the DRX OffDuration.

16. The method of claim 15, wherein transmitting the data using any configured grant associated with the first HARQ process while the timer is running during the DRX OffDuration does not apply to retransmissions.

17. The method of claim 16, wherein retransmissions associated with the first HARQ process are allowed during the DRX OffDuration when the timer expires.

18. The method of claim 15, further comprise:
receiving, from the network, a configuration related to the transmission of data transmitted during the DRX OffDuration, wherein the configuration comprises an indication of a logical channel (LCH), a radio bearer or a quality of service (QOS) flow for which transmitting data using any grant associated with the first HARQ process while the timer is running during the DRX OffDuration is allowed.

19. The method of claim 18, wherein the indication of the LCH comprises an indication of a priority of the LCH.

20. The method of claim 15, further comprise:
determining, whether a transmission of second data using any configured grant associated with the first HARQ process while the timer is running during the DRX OffDuration is allowed based on a logical channel (LCH), a radio bearer or a quality of service (QOS) flow relating to at least one of the first data and the second data.
